(19) United States
(12) Patent Application Publication
(10) Pub. No.: US 2026/0086772 A1
(43) Pub. Date: Mar. 26, 2026

(54) Montgomery Reduction in Cryptographic Operations

(71) Applicant: Infineon Technologies AG, Neubiberg (DE)

(72) Inventor: Wieland Fischer, München (DE)

(21) Appl. No.: 19/339,173

(22) Filed: Sep. 24, 2025

(30) Foreign Application Priority Data
Sep. 26, 2024 (DE) 102024209342.4

(51) Int. Cl. G06F 7/72; H04L 9/32

(52) U.S. Cl. CPC G06F 7/728; H04L 9/3247

(57) ABSTRACT

An apparatus and a method for performing a Montgomery reduction of an input C modulo a modulus N, in particular in the framework of a Montgomery multiplication, comprising: (i) performing a multiplication to obtain an approximated product Y on the basis of a value D and the modulus N, wherein only a higher-order part of the approximated product Y is computed and/or approximated on the basis of an incomplete execution of the multiplication, and wherein the value D is derived from the input C and an auxiliary integer N′ of the Montgomery reduction, (ii) determining a sum by adding a word or partial word of the input C to a word or partial word of the approximated product Y, (iii) determining a carry on the basis of the sum, and (iv) adding the carry to the input C or to a value derived from the input C.

### TECHNICAL FIELD

The present approaches relate to the Montgomery reduction, in particular the Montgomery multiplication.

### BACKGROUND

Montgomery reduction is a technique used in cryptographic algorithms to speed up modular multiplications. Improvements in efficiency when Montgomery reduction is carried out in cryptographic circuits are desirable.

### SUMMARY

In particular, the problem addressed is that of improving known approaches and, in particular, creating a more efficient way of performing the Montgomery reduction.

This problem is solved in accordance with the features of the independent claims. Preferred embodiments can be gathered from the dependent claims, in particular.

These examples proposed herein may be based on at least one of the following solutions. In particular, combinations of the following features can be used to achieve a desired result. The features of the device may be combined with features of the method or vice versa.

For example, an apparatus for performing a Montgomery reduction of an input C modulo a modulus N is proposed, in particular within the framework of a Montgomery multiplication, wherein the apparatus comprises a processing unit that is configured for
performing a multiplication to obtain an approximated product Y on the basis of a value D and the modulus N,
   wherein only a higher-order part of the approximated product Y is computed and/or approximated on the basis of an incomplete execution of the multiplication,
   wherein the value D is derived from the input C and an auxiliary integer N′ of the Montgomery reduction,
determining a sum by adding a word or partial word of the input C to a word or partial word of the approximated product Y,
determining a carry on the basis of the sum,
adding the carry to the input C or to a value derived from the input C.

In addition, it should be noted that the higher-order part of the approximated product Y comprises the most significant bit (MSB) in particular.

In a development, the processing device is configured such that the value D is derived from a multiplication of the input C and the auxiliary integer N′ modulo 2ⁿ, where n is determined by a word width of an integer representation and a number of words.

In this context, it should be noted that the addition of “modulo 2ⁿ” means that only the lower half of the product of input C and auxiliary integer N′ is determined.

In a development, the processing device is configured such that the approximated product Y or a value derived therefrom, the carry and the input C or a value derived therefrom are added.

In a development, the processing device is configured such that a value Y′ derived from the approximated product Y is determined according to

$${Y}^{′} = YdivW .$$

In a development, the processing device is configured such that a value Y″ derived from the approximated product Y is determined according to

$${Y}^{″} = {YdivW}^{2} .$$

In a development, the processing device is configured such that a value C′ derived from the input C is determined according to

$${C}^{′} = {CdivW}^{m - 1} .$$

In a development, the processing device is configured such that a value C″ derived from the input C is determined according to

$${C}^{″} = {CdivW}^{m} .$$

In a development, the processing device is configured such that the input C is a long integer to be reduced, which is determined by a long integer multiplication of two integers.

In a development, the auxiliary integer N′ is determined by

$${N}^{′} := - {N}^{- 1} mod {W}^{m} .$$

In a development, the carry is determined to be 0, 1 or 2.

In a development, the processing device is configured such that
the carry is determined to be 0 if the sum is equal to 0,
the carry is determined to be 1 if the sum is greater than 0 and less than or equal to a base of the integer representation,
the carry is determined to be 2 if the sum is greater than the base of the integer representation.

In a development, the processing device is configured such that the carry is determined to be 0, 1 or 2 by a rounding based on

$$( C + Y + m ) div W ,$$

where
m denotes a number of words of modulus N and
W denotes a base for the integer representation.

In a development, the processing device is configured for carrying out a cryptographic operation, in particular encryption, decryption, signature creation and/or signature verification.

In a development, the processing device comprises one of the following or is configured as one of the following:
a processor,
a chip,
a cryptomodule.

To solve the problem, a method for the Montgomery reduction of an input C modulo a modulus N is proposed, in particular within the framework of a Montgomery multiplication, comprising:
performing a multiplication to obtain an approximated product Y on the basis of a value D and the modulus N,
   wherein only a higher-order part of the approximated product Y is computed and/or approximated on the basis of an incomplete execution of the multiplication,
   wherein the value D is derived from the input C and an auxiliary integer N′ of the Montgomery reduction,
determining a sum by adding a word or partial word of the input C to a word or partial word of the approximated product Y,
determining a carry on the basis of the sum,
adding the carry to the input C or to a value derived from the input C.

In a development, the value D is derived from a multiplication of the input C and the auxiliary integer N′ modulo 2ⁿ, where n is determined by a word width of an integer representation and a number of words.

In a development, the approximated product Y or a value derived therefrom, the carry and the input C or a value derived therefrom are added.

In a development, a value Y′ derived from the approximated product Y is determined according to

$${Y}^{′} = Y div W .$$

In a development, a value Y″ derived from the approximated product Y is determined according to

$${Y}^{″} = Y div {W}^{2} .$$

In a development, a value C′ derived from the input C is determined according to

$${C}^{′} = C div {W}^{m - 1} .$$

In a development, a value C″ derived from the input C is determined according to

$${C}^{″} = C div {W}^{m} .$$

In a development, the input C is a long integer to be reduced, which is determined by a long integer multiplication of two integers.

In a development, the auxiliary integer N′ is determined by

$${N}^{′} := - {N}^{- 1} mod {W}^{m} .$$

In a development, the carry is determined to be 0, 1 or 2.

In a development,
the carry is determined to be 0 if the sum is equal to 0,
the carry is determined to be 1 if the sum is greater than 0 and less than or equal to a base of the integer representation,
the carry is determined to be 2 if the sum is greater than the base of the integer representation.

In a development, the carry is determined to be 0, 1 or 2 by a rounding based on

$$( C + Y + m ) div W ,$$

where
m denotes a number of words of modulus N and
W denotes a base for the integer representation.

### BRIEF DESCRIPTION OF THE FIGURES

The above-described properties, features and advantages of this invention and the way in which they are achieved will be explained further in association with a schematic description of exemplary embodiments which are explained in greater detail in association with the drawings.

In this case, identical or identically acting elements may be provided with identical reference signs, for the sake of clarity.

FIG. 1 shows an exemplary implementation of the Montgomery algorithm for computing

$$F := A {⋆}_{n} B .$$

FIG. 2 shows an exemplary notation of an algorithm for word-wise computation of

$$F := A {⋆}_{n} B .$$

FIG. 3 shows an exemplary implementation of step 3 of the Montgomery algorithm from FIG. 1.

FIG. 4 shows an alternative exemplary implementation of step 3 of the Montgomery algorithm from FIG. 1.

FIG. 5 shows a further exemplary implementation of step 3 of the Montgomery algorithm from FIG. 1.

FIG. 6 shows, by way of example, an arrangement comprising a processing unit that provides a cryptographic output dependent on an input.

FIG. 7 shows a processing apparatus for implementing a cryptographic solution by means of at least one cryptomodule.

### DETAILED DESCRIPTION

Montgomery multiplication is an approach for implementing algorithms that are based on modular arithmetic of long integers. For example, long integers are integers that are suitable for elliptic curve cryptography and RSA algorithms. These can be integers within a range [2¹⁶⁰, 2⁴⁰⁹⁶] or greater. While modular additions and subtractions are easy to implement, the operation of modular multiplication is much more complex. Modular multiplication is the operation

$$F := A \cdot B mod N$$

where N is an odd positive integer less than 2ⁿ, and A, B∈[0, N[ are any integers. The expression F denotes the uniquely defined integer from the interval [0, N[ in such a way that

$$A \cdot B - F$$

is divisible by N. Hence F may also be defined as follows:

$$F = A \cdot B - Q \cdot N , where Q := ⌊ \frac{A \cdot B}{N} ⌋ \qquad ( 1 )$$

Thus, the largest multiple of N that is just less than or equal to this integer is subtracted from A. B. Should

$$A \cdot B = ( \frac{A \cdot B}{N} ) \cdot N$$

apply, then Q is just the biggest integer factor that forms this multiple.

Montgomery multiplication is a variant of modular multiplication. It is defined by

$$A {⋆}_{n} B := A \cdot B \cdot {2}^{- n} mod N \qquad ( 2 )$$

Here 2⁻ⁿ is defined as the modular inverse of 2ⁿ modulo N. If the value n is clear from the context, n can be omitted from the notation.

What follows are exemplary explanations as to how Montgomery multiplication can be implemented on a processor of word width w. In particular, an embodiment that can be applied to a specific implementation is presented.

The following notations apply:
W is the base of the integer representation.
The base W is a power of two, i.e. W=2ⁿ. w is the word width of the integer representation; for example, it may be a width of a processor word (in bits). Exemplary values for w are 8, 16, 32, 64, or 128. Additionally, w may equal 2 in the case of a binary representation.
The modulus N is exactly m (≥1) words long. The assumption can be made that:

$${W}^{m - 1} < N < {W}^{m} . \qquad ( 3 )$$

The left-hand part of the inequality is not strict but assumed to be so for a simplified description. For the sake of completeness, it should be mentioned that N<W^{m-1} may also apply. As a result of this simplified description, the following applies:

$$n = m \cdot w or {2}^{n} = {W}^{m} . \qquad ( 4 )$$

### Mathematical Realization of the Montgomery Multiplication

The purpose of the Montgomery multiplication comprises an implementation of a normal modular multiplication. Therefore, no modular multiplication can be used to implement the Montgomery multiplication itself.

The known algorithm by P. L. Montgomery uses an auxiliary integer

$${N}^{′} := - {N}^{- 1} mod {2}^{n} \qquad ( 5 )$$

where N′ is the unique integer from an interval [0, 2ⁿ[ with the property

$$( N \cdot {N}^{′} + 1 ) mod {2}^{n} = 0 .$$

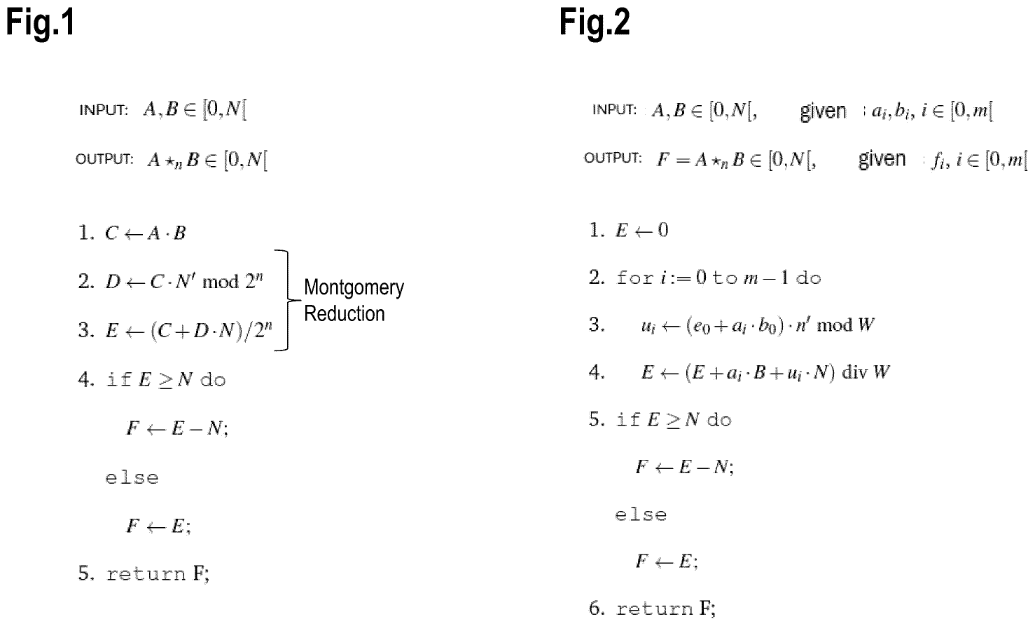

FIG. 1 shows an exemplary implementation of the Montgomery algorithm for computing

F:=A*ₙB in a common notation in five steps 1 to 5. The value N′ may be computed in advance.

It should be noted that the correctness of the result can be recognized by the fact that the result of the product C=A·B is only still modified by multiples of N and then divided by 2ⁿ. This corresponds to the definition of A*ₙB. Furthermore, an estimation of the values shows that E∈[0,2N[ and therefore F∈[0, N[.

In step 2, the modular operations are computed modulo 2ⁿ. It is noteworthy that the operations modulo 2ⁿ only correspond to the normal non-modular operations together with the forgetting of the bit positions beyond the n-th position.

In step 4, the value C+D·N can be divided by 2ⁿ as a result of choosing N′ or D. In other words: The n least significant bits of C+D·N are all equal to 0. Dividing by 2ⁿ corresponds to the forgetting of the least significant n bits or shifting the integer down by n bit positions.

All steps from step 2, and in particular steps 2 and 3, may be referred to as a Montgomery reduction. Step 4 may be part of the Montgomery reduction if the output should be restricted from a range [0,2N[ to a range [0,N[ (e.g. for a subsequent multiplication).

### Implementation

The Montgomery multiplication can be implemented with the usual means of a processor unit (e.g. a CPU), since all operations can be traced back to the normal non-modular operations. The operation thus consists of non-modular additions, subtractions and multiplications of long integers. These operations are composed of the corresponding short operations that can be directly implemented with the CPU.

However, a naïve implementation of the algorithm above results in significant performance losses.

Processors with a word width of w bits are used in an exemplary implementation. The following representation is obtained for a long integer A:

$$A = {a}_{m - 1} \cdot {W}^{m - 1} + ⋯ + {a}_{1} \cdot W + {a}_{0} , where {a}_{i} ∈ [ 0 , W [ \qquad ( 6 )$$

This applies correspondingly to all further integers. Both representations, i.e. the representation according to formula (6) and the naïve representation, can be used equally and also mixedly. In an implementation, such an integer can be saved and used as an array of m words

$$\begin{matrix}{( {a}_{i} )}_{i = 0}^{m = 1} or \\ a [ m ] .\end{matrix}$$

The multiplication of an integer A of word length m

$$A = {a}_{m - 1} \cdot {W}^{m - 1} + ⋯ + {a}_{1} \cdot W + {a}_{0} , where {a}_{i} ∈ [ 0 , W [$$

by an integer B of word length m′

$$B = {b}_{{m}^{′} - 1} \cdot {W}^{{m}^{′} - 1} + ⋯ + {b}_{1} \cdot W + {b}_{0} , where {b}_{j} ∈ [ 0 , W [$$

can for example be described as follows:

$$A \cdot B = {\sum }_{i : = 0}^{m - 1} {\sum }_{j . = 0}^{{m}^{′} - 1} {a}_{i} \cdot {b}_{j} \cdot {W}^{i + j} . \qquad ( 7 )$$

This operation has the complexity of m·m′: Only the relevant elementary multiplications aᵢ·bⱼ are counted in this context.

Hereinafter, elementary multiplications refer to operations that can normally be executed directly on a CPU, i.e. preferably an operation of the form:

$$mul : [ 0 , W {[}^{2} \to [ 0 , {W}^{2} [ , ( {a}_{i} , {b}_{j} ) \to {a}_{i} \cdot {b}_{j}$$

or in word notation

$$mul : [ 0 , W {[}^{2} \to [ 0 , W {[}^{2} , ( {a}_{i} , {b}_{j} ) \to ( {a}_{i} \cdot {b}_{j} mod W , {a}_{i} \cdot {b}_{j} div W ) .$$

Thus, m² times mul must be applied for the computation of C=A·B. Furthermore, an unspecified number of summations with carry handling are performed.

This also applies accordingly to the multiplications D·N in step 3 and C·N′ in step 2. Note that although C is an integer 2m words long, the following holds true:

$$C \cdot {N}^{′} mod {2}^{n} = ( C mod {2}^{n} ) \cdot {N}^{′} mod {2}^{n} ,$$

and hence this is effectively a multiplication with m′=m.

Overall, a first estimate of the complexity of a Montgomery multiplication is determined to be 3m² elementary multiplications. However, this is suboptimal. Thus, in step 2, the complete execution of the multiplication C·N′ as

$$C \cdot {N}^{′} = {\sum }_{i , j := 0}^{m - 1} {c}_{i} \cdot {n}_{j}^{′} \cdot {W}^{i + j}$$

is not required since the values

$${c}_{i} \cdot {n}_{j}^{′} \cdot {W}^{i + j}$$

are lost completely due to the following operation

$$mod {2}^{n} ≡ mod {W}^{m}$$

should i+j≥m apply. Thus, it is enough to compute only

$${\sum }_{i + j < m} {c}_{i} \cdot {n}_{j}^{′} \cdot {W}^{i + j} \qquad ( 8 )$$

and this corresponds to

$$\frac{m \cdot ( m + 1 )}{2}$$

elementary multiplications only. This measure can reduce the complexity of the Montgomery multiplication from

$$3 \cdot {m}^{2} to 2.5 \cdot {m}^{2} + \frac{m}{2} .$$

How the complexity of the Montgomery multiplication can be reduced further will be explained hereinafter.

### Word-Wise Implementation of the Montgomery Multiplication

Implementations are proposed that, from the outset, take into account that the long integers consist of individual words. The representation of integers as an array, especially a tuple, of words is still given by

$$A = {a}_{m - 1} \cdot {W}^{m - 1} + … + {a}_{1} \cdot W + {a}_{0} , where {a}_{i} ∈ [ 0 , W [ \qquad ( 9 )$$

This also applies to all further integers. Both representations can be used equally and mixedly.

### Use is Made of the Auxiliary Integer

$${n}^{′} := - {N}^{- 1} mod {2}^{w} . \qquad ( 10 )$$

Hence n′ is the unique integer from the interval [0, 2^{w}[ with the property

$$( N \cdot {n}^{′} + 1 ) mod {2}^{w} = 0 .$$

FIG. 2 shows an exemplary notation of an algorithm for word-wise computation of

F:=A*ₙB in six steps 1 to 6. The value n′ may be computed in advance.

Additionally, reference is made to [A. J. Menezes et al.: Handbook of Applied Cryptography, Second Edition, 1997, CRC Press LLC, Boca Raton, Section 14.3.2 Barrett reduction, pages 600 to 603].

The operation in step 3 is implemented only on words. It can therefore be computed directly on the CPU and requires two CPU multiplications (and one addition). The result is once again a word.

The operation in step 4 comprises two long-integer multiplications, in each case a word (aᵢ, uᵢ) multiplied by a long integer (B,N), where the long integer has a word length m. In total, the operation requires 2m CPU multiplications (and CPU additions).

This version of the Montgomery multiplication presented here has the additional advantage that the integer n′ computed in advance is only one word, and the corresponding pre-computation can simply take place on the CPU, whereas N′ is a long integer, the computation of which is more complex.

The algorithm has a complexity of m·(2m+2)=2m²+2m elementary multiplications.

The complexity can be further reduced to 2m²+m: The operation aᵢ·b₀ of step 3 can be reused in the computation of aᵢ·B in step 4. Alternatively, the computation E+aᵢ·B may be performed before step 3; with e₀, the result already contains the value
(e₀+aᵢ·b₀)mod W that is required for step 3.

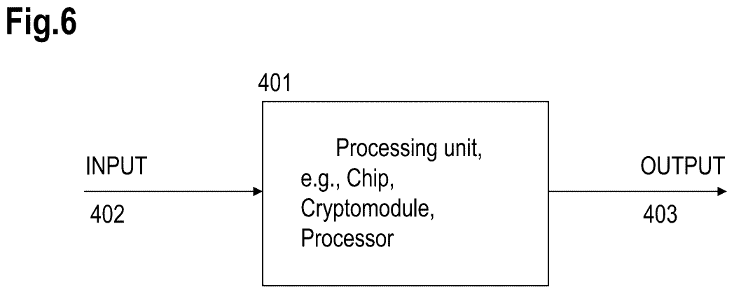

The Montgomery reduction described here can generally be referred to as a modular reduction. By way of example, FIG. 6 shows an arrangement comprising a processing unit 401, which by way of example receives an input 402, performs a cryptographic method, e.g. an encryption, a decryption, a signature creation or a signature verification, and, as a result, provides a corresponding output 403 (e.g. encrypted data, decrypted data, signature, verified signature, errors, etc.). The processing unit 401 may be embodied as a chip, a cryptomodule or a processor or comprise at least a chip, a cryptomodule and/or a processor. The cryptographic method performed on the processing unit 401 uses modular multiplications. The modular reduction described herein can be used as part of modular multiplication.

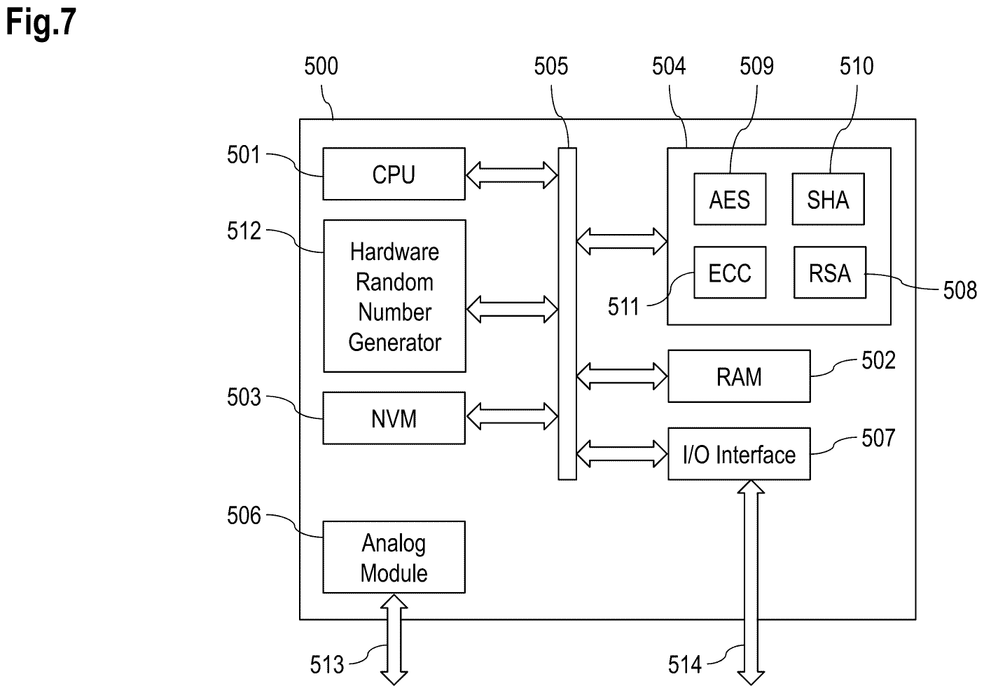

FIG. 7 shows a processing apparatus 500 comprising a CPU 501, a RAM 502, a non-volatile memory (NVM) 503, a cryptomodule 504, an analog module 506, an input/output interface 507 and a hardware random number generator 512.

In this example, the CPU 501 has access to at least one cryptomodule 504 by way of a common bus 505, to which each cryptomodule 504 is coupled. In particular, each cryptomodule 504 may comprise one or more cryptocores, in order to carry out certain cryptographic operations. Exemplary cryptocores are:
an AES core 509 (AES: Advanced Encryption Standard),
an SHA core 510 (SHA: Secure Hash Algorithm),
an ECC core 511 (ECC: Error Checking and Correcting) and
an RSA Core 508 (RSA: Rivest-Shamir-Adleman, relates to a core that implements the RSA algorithm).

The CPU 501, the hardware random integer generator 512, the NVM 503, the cryptomodule 504, the RAM 502 and the input/output interface 507 are connected to the bus 505. The input/output interface 507 may have a connection to other pieces of equipment that may be similar to the processing apparatus 500.

The cryptomodule 504 may be equipped with or without hardware-based security features.

The bus 505 itself may be masked or open. Instructions for performing the steps described here may, in particular, be saved in the NVM 503 and processed by the CPU 501. The processed data may be saved in the NVM 503 or in the RAM 502. Supporting functions may be provided by the cryptomodules 504.

The steps of the method described here may be carried out exclusively or at least partially on the cryptomodule 504. In particular, at least one modular multiplication comprising the Montgomery reduction described herein may be performed on the cryptomodule 504.

In an example, long integer multiplications can be performed in the cryptomodule 504 or at least partially in the CPU 501. In another example, non-modular integer multiplications are always executed in cryptomodule 504.

The processing equipment 500 may be a chip card that is operated by direct electrical contact or by way of an electromagnetic field. The processing apparatus 500 may be a fixed circuit or may be based on reconfigurable hardware (e.g. field programmable gate array, FPGA). The processing apparatus 500 may be connected to a personal computer, a microcontroller, an FPGA or a smartphone. Alternatively, processing equipment 500 may be embodied as a cryptocore, hardware security module (HSM) or any other hardware module.

### Special Features of the Implementation

The word-wise Montgomery algorithm described above has many advantages in the implementation on a CPU: The individual steps can be performed on the CPU, and the algorithm is optimized to the number of elementary multiplications required.

The estimate for the actual performance of an algorithm implementation on a CPU, however, depends on several additional factors:
The algorithm consists not only of multiplications but also of additions/subtractions with or without handling the carry (carry handling). What a conversion on a CPU looks like depends on the commands available.
For example, a CPU is equipped with a small memory, known as the register file, and a large memory, the RAM. The register file comprises a number (usually 16 or 32) of words (registers) of width w. Fast basic arithmetic operations (multiplication, etc.) are only possible on these registers.
Movement of data between the RAM and a register (if implemented in software) is brought about using commands. If arithmetic operations only work on registers, the algorithm (or software) must also ensure that the corresponding input values for the operations are available in the registers in good time. Loading and saving register values requires additional time, especially in the case of software-only implementations. In special hardware implementations, such data movements might optionally be performed in the background but then require complex logistics.
In modern CPUs, the elementary multiplications often need only one clock cycle for execution. Thus, an elementary multiplication might optionally only cost as much runtime as an elementary addition and possibly less runtime than a load or save operation. Thus, an algorithm that is optimized in respect of minimizing elementary multiplications but requires many load/save operations and additions may become slower.

An assumption made by way of example hereinafter is that an elementary operation only requires one clock cycle. Thus, the execution time for a Montgomery multiplication is at least 2m²+m clock cycles.

The execution time of an implementation depends on the number of elementary multiplications required by the algorithm, the number of additions required, and the skill with which the register file is used.

If m is small enough such that e.g. all the required input values for the Montgomery multiplication A, B, N, n′ can be kept in the register file, then the execution time is dominated by the multiplications and additions; in addition, only the loading time of A and B and the time for writing back the result must be taken into account.

If m is in a middling range such that perhaps only some of the values can be kept in the register file, e.g. only B, N, n′, then a favorable performance of the implementation can be achieved by skillful reloading of a; in the background at the right time.

However, if m is beyond the size of the registry such that it is not even possible to keep any of the integers involved completely in the register file, then the runtime of naïve implementations is dominated by loading and saving operations. Should the data not be available in the register file, an elementary operation requires two load operations and possibly also one save operation.

A conventional optimization leads to a significantly increased complexity of software or hardware flow control. Optimization is made even more difficult if the more complicated word-wise variant of the Montgomery multiplication should be implemented instead of non-modular multiplication.

### Improved Approach

By way of example, the assumption is made that m is a large integer. For example, this applies to implementations of RSA algorithms. Here, the runtime of the Montgomery multiplication is dominated by the quadratic factor m², the linear factor is rather negligible. By way of example, the assumption is made hereinafter that a non-modular multiplication of two integers of word length m can be implemented by a number m²+O(m) of clock cycles.

For example, in this case, it is possible to assume the original monolithic implementation of Montgomery multiplication, in which only non-modular multiplications are used. This variant of the Montgomery multiplication has a complexity of approx. 3m² clock cycles. Thus, an implementation with the complexity of 3m²+O(m) is realistic. However, this means a performance loss of at least 50%.

### Step 2

Further improvements are needed to get back to a complexity in the order of 2m²+O(m). As described above, it is merely necessary to carry out the multiplication according to step 2 in the lower half only; see equation (8).

Such a half multiplication can be realized using the same methods as a complete multiplication and can be realized with a runtime of 0.5m²+O(m). This results in a total runtime of 2.5m²+O(m) clock cycles for a Montgomery multiplication.

### Step 3

A further reduction of the complexity from a factor of 2.5 to a factor of 2 is more complex and takes place in step 3. There

$$E = \frac{( C + D \cdot N )}{{2}^{n}} = \frac{C}{{2}^{n}} + \frac{( D \cdot N )}{{2}^{n}} \qquad ( 11 )$$

is computed.

The choice of D ensures that C+D·N is divisible by 2ⁿ=W^{m} or that E is an integer. For this reason, it is sufficient to compute only the upper half of the sum C+D·N.

Thus, it is possible to compute only the top half of D·N, and this can be added to the top half of C. This roughly corresponds to a computational outlay of approx. m²/2 instead of m² elementary multiplications or clock cycles. In this case, the overall runtime could be reduced to 2m²+O(m).

Furthermore, an approach could be developed as follows:

$$Approach : E ← C div {2}^{n} + ( D \cdot N ) div {2}^{n} \qquad ( 12 )$$

where “div” is integer division without a remainder.

In most cases, C is not divisible by 2ⁿ; in that case, the value (C mod 2ⁿ) must be supplemented by (D·N mod 2ⁿ) to form the value 2ⁿ. The correct solution is therefore

$$E ← \{ \begin{matrix}C div {2}^{n} + ( D \cdot N ) div {2}^{n} , if {2}^{n} \vert C \\ C div {2}^{n} + ( D \cdot N ) div {2}^{n} + 1 , otherwise\end{matrix} \qquad ( 13 )$$

This approach still has the following problems:
It requires a check of C mod 2ⁿ=0; for this, the whole lower half of C must be checked.
The term (D·N) div 2ⁿ requires that D·N be computed in full, but this is in contradiction to the effort optimization described herein.

The following term

$$X := D \cdot N = {\sum }_{i , j := 0}^{m - 1} {d}_{i} \cdot {n}_{j} \cdot {W}^{i + j}$$

can be approximated by

$${X}^{′} := {\sum }_{i + j \geq m} {d}_{i} \cdot {n}_{j} \cdot {W}^{i + j} .$$

This term contains

$$( m - 1 ) + ( m - 2 ) + … + 1 = \frac{( m - 1 ) m}{2} = \frac{{m}^{2} - m}{2}$$

elementary products. In this context, the following holds true:

$$X - {X}^{′} := {\sum }_{i + j \leq m - 1} {d}_{i} \cdot {n}_{j} \cdot {W}^{i + j} {<}^{\text{(*} )} {\sum }_{i + j = m - 1} W \cdot W \cdot {W}^{i + j} = m \cdot {W}^{( m + 1 )} .$$

(*): It should be noted in this context that the terms with i+j<m−1 are absorbed by the terms with i+j=m−1 when dᵢ=nⱼ=W is rounded up.

A further improved approximation is:

$${X}^{″} := {\sum }_{i + j \geq m - 1} {d}_{i} \cdot {n}_{j} \cdot {W}^{i + j} .$$

This term contains

$$m + ( m - 1 ) + … + 1 = \frac{m ( m + 1 )}{2} = \frac{{m}^{2} + m}{2}$$

elementary products. In this context, the following holds true:

$$X - {X}^{″} := {\sum }_{i + j \leq m - 2} {d}_{i} \cdot {n}_{j} \cdot {W}^{i + j} {<}^{\text{(*} )} {\sum }_{i + j = m - 2} W \cdot W \cdot {W}^{i + j} = ( m - 1 ) \cdot {W}^{m} .$$

Here, too, the value X/2ⁿ may still differ slight from X″/2ⁿ by up to m. The next approximation is:

$${X}^{′′′} := {\sum }_{i + j \geq m - 1} {d}_{i} \cdot {n}_{j} \cdot {W}^{i + j} .$$

This term now contains

$$( m - 1 ) + m + ( m - 1 ) + ⋯ + 1 = \frac{{m}^{2} + 3 m}{2} - 1$$

elementary products and the following holds true:

$$X - {X}^{′′′} := {\sum }_{i + j \leq m - 3} {d}_{i} \cdot {n}_{j} \cdot {W}^{i + j} {<}^{\text{(*} )} {\sum }_{i + j = m - 3} W \cdot W \cdot {W}^{i + j} = ( m - 2 ) \cdot {W}^{m - 1}$$

and hence

$$\frac{X}{{W}^{m}} - \frac{{X}^{′′′}}{{W}^{m}} < \frac{m - 2}{W} . \qquad ( 14 )$$

In the event of m−2<W, this means that

$$X d i v {2}^{n} - {X}^{′′′} div {2}^{n} ∈ \{ 0 , 1 \} \qquad ( 15 )$$

and hence

$$E ← ( C div {2}^{n} ) + ( {X}^{′′′} div {2}^{n} ) + ϵ , where ϵ ∈ \{ 0 , 1 , 2 \} \qquad ( 16 )$$

is true. A specific implementation requires a criterion on the basis of which a decision in relation to the value of ε can be made. The following estimates can be used for this purpose:

$${C}^{′} = C div {W}^{m - 1} ⇒ 0 \leq ( \frac{C}{{W}^{m}} - \frac{{C}^{′}}{W} ) < \frac{1}{W} \qquad ( 17 )$$

On account of Equation (14), the following holds true:

$$Y : = \frac{{X}^{′′′}}{{W}^{m - 2}} = {\sum }_{i + j \geq m - 2} {d}_{i} \cdot {n}_{j} \cdot {W}^{i + j - ( m - 2 )} ⇒ 0 \leq \frac{X}{{W}^{m}} - \frac{Y}{{W}^{2}} < \frac{m - 2}{W} . \qquad ( 18 )$$

Overall, this results in:

$$0 \leq ( \frac{C}{{W}^{m}} + \frac{X}{{W}^{m}} ) - \frac{( {C}^{′} + \frac{Y}{W} )}{W} < \frac{m - 1}{W} . \qquad ( 19 )$$

In other words,

$$( {C}^{′} + \frac{Y}{W} ) / W$$

is a good approximation to E and differs therefrom by less than (m−1)/W. Thus, the following holds true:

$$\frac{( {C}^{′} + \frac{Y}{W} )}{W} ∈ ] E - \frac{m - 1}{W} , E ] \qquad ( 20 )$$

or including the rounding error

$$\frac{{C}^{′} + ( Y div W )}{W} ∈ ] E - \frac{m}{W} , E ] or \qquad ( 21 )$$

$$\frac{{C}^{′} + ( Y div W ) + m}{W} ∈ ] E , E + \frac{m}{W} ] . \qquad ( 22 )$$

Under the assumption that m<W, the following follows:

$$E = ( {C}^{′} + ( Y div W ) + m ) div W \qquad ( 23 )$$

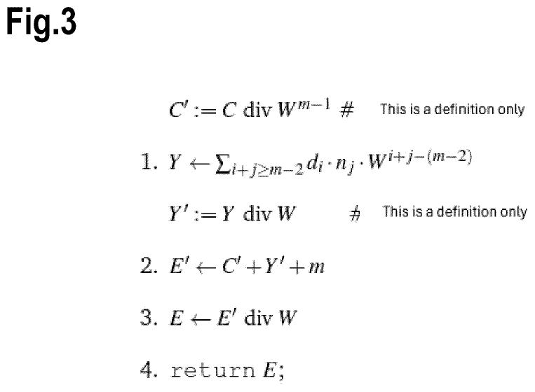

FIG. 3 shows an exemplary implementation of step 3 of the Montgomery algorithm from FIG. 1. This algorithm requires

$$\frac{{m}^{2}}{2} + 1.5 m - 1$$

elementary multiplications. Instead of +m in step 3, it is also possible to add any integer from the interval [m, W−m[.

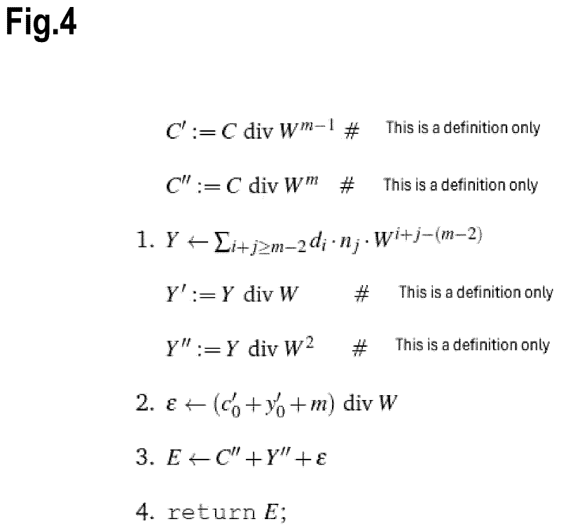

If it is taken into account that in step 2 it is not the value e₀′ of the lowest word of E′ but only the carry to the next higher word that is of interest, then this gives rise to an alternative implementation of step 3 of the Montgomery algorithm, which is shown in FIG. 4. In this case, ε in the algorithm corresponds to e from Equation (16). It can only take the values of 0, 1, 2.

In the above algorithm, the following criterion applies to ε:

$$ϵ = \{ \begin{matrix}2 , & if {c}_{0}^{′} + {y}_{0}^{′} > W \\ 1 , & if W \geq {c}_{0}^{′} + {y}_{0}^{′} > 0 \\ 0 , & if {c}_{0}^{′} + {y}_{0}^{′} = 0.\end{matrix} \qquad ( 24 )$$

This criterion has the advantage that the value m no longer occurs. Although m<W still applies, an implementation of the criterion need not have any knowledge of m. Another advantage is the expedient implementation on a CPU.

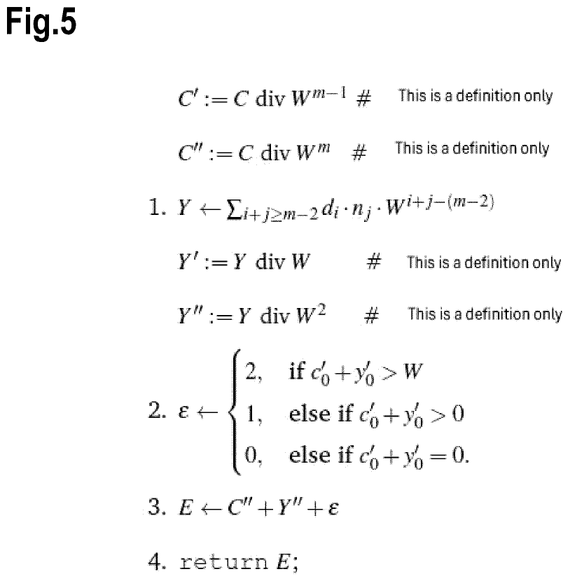

Based on this, FIG. 5 shows a further alternative for implementing step 3 of the Montgomery algorithm.

In addition, it should be noted that any other criterion that maps the ranges {0},

]W−m, W], and ]2W−m, 2W] to the values 0, 1, 2 is possible in step 2.

### Benefits and Other Aspects

The approach described herein has several advantages. Thus, the solution may be used when the word-wise implementation of the Montgomery multiplication causes performance losses. This may be the case if
the long integers involved are too large to be held in the register file,
the loading and saving data in the register file (from/to RAM) takes longer than the actual elementary computations or
the logistics of data management in the register file becomes complicated and possibly even unmanageable.

A further advantage that the approach described here only requires that there is an implementation of simple non-modular multiplications of long integers, which can preferably be started or stopped “in the middle”.

The approach provides a runtime of 2m²+O(m).

Another advantage is that the criterion for computing ε is implementable without the knowledge of m. This is advantageous in hardware implementations, for example.

The examples described herein allow the determination of a carry of value 0, 1 or 2 in the context of a Montgomery reduction or Montgomery multiplication of long integers.

In particular, at least one of the following features may be considered in one of the solutions presented here:
A long integer (C) to be reduced. Montgomery multiplication computes the integer to be reduced by a long integer multiplication of two given long integers, while the integer to be reduced is given directly in a Montgomery reduction.
A long multiplication (Y) that computes or approximates only the upper half of a product by an incomplete execution of the multiplication.
A (partial) word of the integer

$$\begin{matrix}ϵ \\ := ( {c}_{0}^{′} + {y}_{0}^{′} + m ) div W .\end{matrix}$$

to be reduced and the approximated product

$$( {y}_{0}^{′} )$$

are added.
Depending on the value of the sum, the carry is determined to be 0, 1 or 2. For example, this is implemented directly according to Equation (24) or by a type of rounding such as

$$ϵ := ( {c}_{0}^{′} + {y}_{0}^{′} + m ) div W .$$

The carry is added to the integer to be reduced or to a value (C″) derived therefrom. For example, this is implemented indirectly, e.g. via C″+Y″+ε according to the variant shown in FIG. 4 above.
The last two points may alternatively be combined, according to the variant shown in FIG. 3.

1. An apparatus for performing a Montgomery reduction of an input C modulo a modulus N, within the framework of a Montgomery multiplication, wherein the apparatus comprises a processing unit that is configured to:
perform a multiplication to obtain an approximated product Y on the basis of a value D and the modulus N, wherein only a higher-order part of the approximated product Y is computed and/or approximated on the basis of an incomplete execution of the multiplication, wherein the value D is derived from the input C and an auxiliary integer N′ of the Montgomery reduction;
determine a sum by adding a word or partial word of the input C to a word or partial word of the approximated product Y;
determine a carry on the basis of the sum; and
add the carry to the input C or to a value derived from the input C.

2. The apparatus of claim 1, wherein the processing device is configured such that the value D is derived from a multiplication of the input C and the auxiliary integer N′ modulo 2ⁿ, where n is determined by a word width of an integer representation and a number of words.

3. The apparatus of claim 1, wherein the processing device is configured such that the approximated product Y or a value derived therefrom, the carry and the input C or a value derived therefrom are added.

4. The apparatus of claim 1, wherein the processing device is configured such that a value Y′ derived from the approximated product Y is determined according to
$${Y}^{′} = Y div W .$$

5. The apparatus of claim 3, wherein the processing device is configured such that a value Y″ derived from the approximated product Y is determined according to
$${Y}^{″} = Y div {W}^{2} .$$

6. The apparatus of claim 1, wherein the processing device is configured such that a value C′ derived from the input C is determined according to
$${C}^{′} = C div {W}^{m - 1} .$$

7. The apparatus of claim 1, wherein the processing device is configured such that a value C″ derived from the input C is determined according to
$${C}^{″} = C div {W}^{m} .$$

8. The apparatus of claim 1, wherein the processing device is configured such that the input C is a long integer to be reduced, which is determined by a long integer multiplication of two integers.

9. The apparatus of claim 1, wherein the auxiliary integer N′ is determined by
$${N}^{′} := - {N}^{- 1} mod {W}^{m} .$$

10. The apparatus of claim 1, wherein the carry is determined to be 0, 1 or 2.

11. The apparatus of claim 1, wherein the processing device is configured such that
the carry is determined to be 0 if the sum is equal to 0,
the carry is determined to be 1 if the sum is greater than 0 and less than or equal to a base of the integer representation,
the carry is determined to be 2 if the sum is greater than the base of the integer representation.

12. The apparatus of claim 1, wherein the processing device is configured such that the carry is determined to be 0, 1 or 2 by a rounding based on
$$( C + Y + m ) div W ,$$
where
m denotes a number of words of modulus N and
W denotes a base for the integer representation.

13. The apparatus of claim 1, wherein the processing device is configured to carry out a cryptographic operation, in particular encryption, decryption, signature creation and/or signature verification.

14. The apparatus of claim 1, wherein the processing device comprises one of the following or is configured as one of the following:
a processor,
a chip,
a cryptomodule.

15. A method for the Montgomery reduction of an input C modulo a modulus N, within the framework of a Montgomery multiplication, comprising:
performing a multiplication to obtain an approximated product Y on the basis of a value D and the modulus N; wherein only a higher-order part of the approximated product Y is computed and/or approximated on the basis of an incomplete execution of the multiplication, wherein the value D is derived from the input C and an auxiliary integer N′ of the Montgomery reduction;
determining a sum by adding a word or partial word of the input C to a word or partial word of the approximated product Y;
determining a carry on the basis of the sum; and
adding the carry to the input C or to a value derived from the input C.

16. The method of claim 15, wherein the value D is derived from a multiplication of the input C and the auxiliary integer N′ modulo 2ⁿ, where n is determined by a word width of an integer representation and a number of words.

17. The apparatus of claim 15, wherein the approximated product Y or a value derived therefrom, the carry and the input C or a value derived therefrom are added.

18. The method of claim 17, wherein a value Y′ derived from the approximated product Y is determined according to
$${Y}^{′} = Y div W .$$

19. The method of claim 17, wherein a value Y″ derived from the approximated product Y is determined according to
$${Y}^{″} = Y div {W}^{2} .$$

20. The method of claim 15, wherein a value C′ derived from the input C is determined according to
$${C}^{′} = C div {W}^{m - 1} .$$

21. The method of claim 15, wherein a value C″ derived from the input C is determined according to
$${C}^{″} = C div {W}^{m - 1} .$$

22. The method of claim 15, wherein the input C is a long integer to be reduced, which is determined by a long integer multiplication of two integers.

23. The method of claim 15, wherein the auxiliary integer N′ is determined by
$${N}^{′} := - {N}^{- 1} mod {W}^{m} .$$

24. The method of claim 15, wherein the carry is determined to be 0, 1 or 2.

25. The method of claim 15, wherein
the carry is determined to be 0 if the sum is equal to 0,
the carry is determined to be 1 if the sum is greater than 0 and less than or equal to a base of the integer representation,
the carry is determined to be 2 if the sum is greater than the base of the integer representation.

26. The method of claim 15, wherein the carry is determined to be 0, 1 or 2 by a rounding based on
$$( C + Y + m ) div W ,$$
where
m denotes a number of words of modulus N and
W denotes a base for the integer representation.
